(19) United States
(12) Patent Application Publication
(10) Pub. No.: US 2011/0282855 A1
(43) Pub. Date: Nov. 17, 2011

(54) SCORING RELATIONSHIPS BETWEEN OBJECTS IN INFORMATION RETRIEVAL

(75) Inventors: Inbal Ronen, Haifa (IL); Sivan Yogev, Givat Haim Meuchad (IL)

(73) Assignee: International Business Machines Corporation, Armonk, NY (US)

(21) Appl. No.: 12/778,162

(22) Filed: May 12, 2010

(51) Int. Cl. G06F 17/30; G06F 15/16

(52) U.S. Cl. 707/706; 707/748; 709/204; 707/E17.008

(57) ABSTRACT

A method, system, and computer program product for scoring relationships between objects in information retrieval are provided. The method includes: receiving a query object as an input in a search, wherein the query object is a query for a searchable entity type; identifying indexed document objects associated with the query object; and identifying facet objects referenced in the indexed document objects, which facet objects share a defined relationship type with the query object. The method calculates for each relationship between a facet object and the query object a weight of relationship. Wherein a query object, document object, and facet object can represent any searchable entity. Calculating a weight of relationship calculates the weight of relationships over all document objects divided by a selected normalization.

### BACKGROUND

This invention relates to the field of information retrieval. In particular, the invention relates to scoring relationship between objects in information retrieval.

Traditional information discovery methods are based on content: documents, terms, and the relationships between them. In the Web 2.0 era, people join the equation, creating documents and tags in many forms. Searches that incorporate personalization, social graphs, content, and personal recommendations are just some of the tasks that can take advantage of this newly formed environment.

Unified search, also known as heterogeneous interrelated entity search, is an emerging concept in information retrieval (IR). In unified search, the search space is expanded to represent heterogeneous information objects such as documents (web-pages, database records), users (authors, readers, taggers), user tags, as provided by collaborative bookmarking systems, and other object types. These objects might be related to each other in several relation types. For example, documents might relate to other documents by referencing each other; a user might be related to a document through authorship relation, as a tagger (a user bookmarking the document), as a reader, or as mentioned in the page's content; users might relate to other users through typical social network relations; and tags might relate to the bookmark they are associated with, and also to their taggers.

The IR system task over such a search space is to allow querying for all supported object types, and retrieving information objects of all types relevant to a given query.

US Patent No. 2009/0327271 discloses a method of information retrieval with unified search between heterogeneous objects. The method includes: indexing a first object as a document in a search index; referencing a second object related to the first object in a facet of the document; and storing a relationship strength between the first and second objects in the facet of the document in the search index. Multiple heterogeneous objects can be related to the first object and referenced in multiple facets of the document, each with its relationship strength to the first object. Scoring an indirect object by indirect relation to a query object can be carried out by aggregating the relationship strengths between the indirect object and the retrieved objects multiplied by the retrieved objects' direct scores of relationship strength to the query object.

### BRIEF SUMMARY

According to a first aspect of the present invention there is provided a method for scoring relationships between objects in information retrieval, comprising: receiving a query object as an input in a search, wherein the query object is a query for a searchable entity type; identifying indexed document objects associated with the query object; identifying facet objects referenced in the indexed document objects, which facet objects share a defined relationship type with the query object; calculating for each relationship between a facet object and the query object a weight of relationship; wherein a query object, document object, and facet object can represent any searchable entity; and wherein said steps are implemented in either: computer hardware configured to perform said identifying, tracing, and providing steps, or computer software embodied in a non-transitory, tangible, computer-readable storage medium.

According to a second aspect of the present invention there is provided a computer program product for aggregation of social network data, the computer program product comprising: a computer readable storage medium having computer readable program code embodied therewith, the computer readable program code comprising: computer readable program code configured to: receive a query object as an input in a search, wherein the query object is a query for a searchable entity type; identify indexed document objects associated with the query object; identify facet objects referenced in the indexed document objects, which facet objects share a defined relationship type with the query object; calculate for each relationship between a facet object and the query object a weight of relationship; wherein a query object, document object, and facet object can represent any searchable entity.

According to a third aspect of the present invention there is provided a system for scoring relationships between objects in information retrieval, comprising: a processor; a query engine for receiving a query object as an input in a search, wherein the query object is a query for a searchable entity type, and for returning results from a search engine of indexed document objects associated with the query object; an indirect relationship mechanism including: a facet object identifying component for identifying facet objects referenced in the indexed document objects, which facet objects share a defined relationship type with the query object; and a relationship computing component for calculating for each relationship between a facet object and the query object a weight of relationship; wherein a query object, document object, and facet object can represent any searchable entity.

According to a fourth aspect of the present invention there is provided a method of providing a service to a customer over a network for scoring relationships between objects in information retrieval, the service comprising: receiving a query object as an input in a search, wherein the query object is a query for a searchable entity type; identifying indexed document objects associated with the query object; identifying facet objects referenced in the indexed document objects, which facet objects share a defined relationship type with the query object; calculating for each relationship between a facet object and the query object a weight of relationship; wherein a query object, document object, and facet object can represent any searchable entity; and wherein said steps are implemented in either: computer hardware configured to perform said identifying, tracing, and providing steps, or computer software embodied in a non-transitory, tangible, computer-readable storage medium.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a schematic diagram representing a search space on which the present invention may operate;

FIG. 2 is a schematic diagram representing a search index in accordance with the present invention;

FIG. 3 is a flow diagram of a method in accordance with the present invention;

FIG. 4 is a flow diagram of a method in accordance with the present intention;

FIG. 5 is a block diagram of a search system as known in the art;

FIGS. 6A and 6B are block diagrams of a search system in accordance with the present invention;

FIG. 7 is a block diagram of a computer system in which the present invention may be implemented; and

FIG. 8 is a representation of a graphical user interface showing the results of a system in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

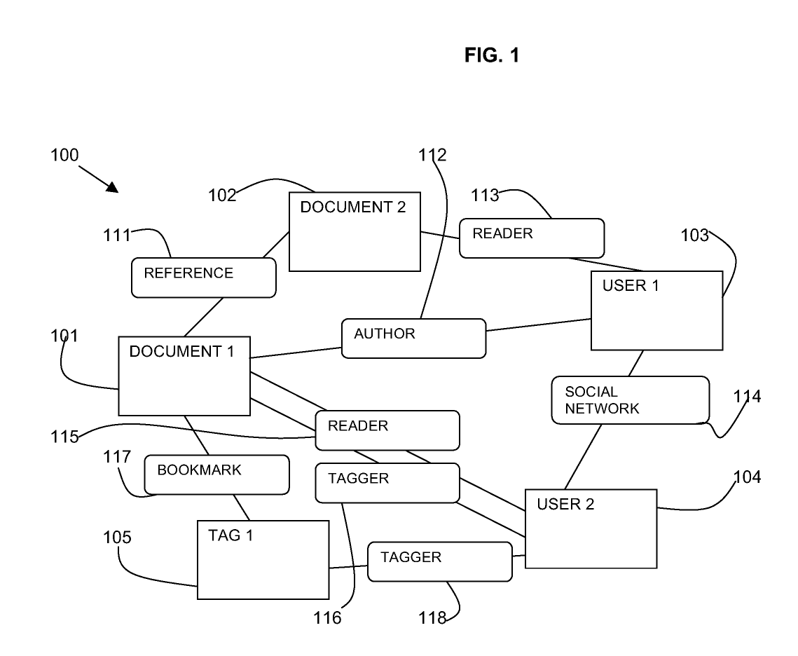

Referring to FIG. 1, a schematic diagram shows a search space 100 with heterogeneous information objects or entities 101-105. The heterogeneous information objects may include documents (web-pages, database records, patent documents, articles), users (authors, readers, taggers), user tags as provided by collaborative bookmarking systems, and other object types. In the illustrated diagram, the objects are document 1 101, document 2 102, user 1 103, user 2 104, and user tag 1 105.

The objects 101-105 are related to each other and the example relationships 111-118 are shown in FIG. 1 as follows:
Document 1 101 references 111 document 2 102.
Document 1 101 has author 112 of user 1 103.
User 1 103 is a reader 113 of document 2 102.
User 1 103 and user 2 104 are related by a social network 114.
User 2 104 is a reader 115 of document 1 101.
User 2 104 is also a tagger 116 of document 1 101.
Tag 1 105 is a bookmark 117 to document 1 101.
User 2 104 is the tagger 118 of the tag 1 105.

A known method of unified search is described in US Patent Application No. 2009/0327271 represents a single object in the system in two ways: as a retrievable document and as a facet (category) of all the objects it relates to. Each direct relation between two objects is defined by attaching a facet representing one object to a document representing the other object. The relationship strength between objects is represented by weighting the facet-document relationship.

For example, in a unified representation of a collaborative bookmarking system, there are three object types—bookmarked web objects (web-pages), taggers (users), and tags. Each object type is associated with a corresponding document—a web-page document, a user document and a tag document. The content of a web-page document is based on the content of the web object it relates to, as well as all tags and descriptions that users have associated with that object. The content of a user document may include some public information about the user such as name, title, hobbies, projects, papers, etc. A tag document will contain the tag only. There are three obvious relationship types in such a system:
Relationship of a user to the tagged web-page is represented as a user-type facet of the corresponding web-page document.
Relationship of a tag with the associated web-page is represented by a tag-type facet of the web-page document.
Relationship of a user with a tag used for bookmarking is represented as a user-type facet of the corresponding tag document.

In conventional faceted search implementations, each document is associated with a list of categories (facets) it belongs to. Those categories are stored as the document attributes within the search index. During the search for a specific query, the categories of all matched documents are retrieved, and for each category a counter of the number of matched documents is provided. The retrieved categories (facets) then might be used by the searcher to narrow his search to a specific facet.

The extension described in US 2009/0327271 is to add to each of the category-document relation a weight that represents the relationship strength. The documents in the index are expanded to include all heterogeneous objects and the facets include categories for all the heterogeneous object types so that a relationship between objects can be defined in the facet index.

When all objects are searched related to a certain object, the result set will contain all entities related directly and indirectly to that object. The directly related objects are extracted by retrieving all entities for which the desired object serves as their facet. Their score is determined according to the relationship strength with the target object.

The indirectly related objects are extracted by retrieving the facets of the direct results. In the following, a scoring mechanism for indirect objects is described based on the multifaceted search implementation.

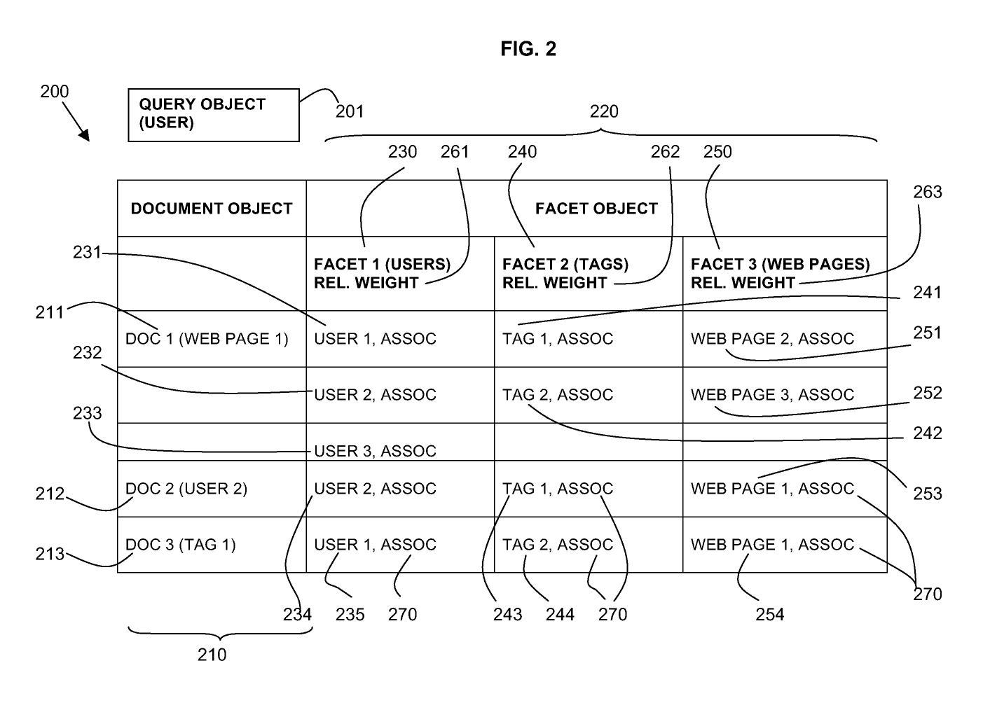

Referring to FIG. 2, a schematic diagram 200 shows a query object 201 (for example, a query of a user) and information retrievable from an index or database of a unified faceted search system. The index includes referenced heterogeneous document objects 210 in the form of document entries 211-213. In the illustrated example, document 1 211 is a web-page 1, document 2 212 is user 1, and document 3 213 is tag 1. These document objects 210 may be returned in the search results for query object 201 due to an association between the document objects 210 and the query object 201. Associations 270 of facet objects 220 are used to weight a document object 210 in the returned results.

Each of the document entries 211-213 has referenced facet objects 220 with three example categories of facet 1 230 for user objects, facet 2 240 for tag objects, and facet 3 250 for web-page objects.

In the illustrated example in FIG. 2, the document 1 211 representing web-page 1 has three users 231-233 in its facet 1 category 230, two tags 241-242 in its facet 2 category 240, and two web-pages 251-252 in its facet 3 category 250.

The document 2 212 representing user 1 has a user 234 in its facet 1 category 230, a tag 243 in its facet 2 category 240, and a web-page 253 in facet 3 category.

The document 3 213 representing tag 1 has a user 235 in its facet 1 category 230, a tag 244 in its facet 2 category 240, and a web-page 254 in facet 3 category.

The document objects 210 returned in the search results for query object 201 reference facet objects 220. A facet object 220 has an indirect relationship to the query object 201 which can be scored across all document objects 210 in which it is referenced.

Entries are stored in the index of facet objects 220 with associations 270 of the relationship between the document object 210 and a facet object 220. The associations 270 are used to determine the relationship type and therefore the weighting of the indirect relationship between facet objects 220 and the query object 201.

The weight for ranking documents is a function of the association 270. The weights of the relationships are generic throughout the query and are shown for each facet object 220 as relative weights 261, 262, 263.

The described method, system and computer product provide the ability to define a set of relationships which are used to calculate indirect object to object scores between a query object and a facet object via a document object. A described example implementation is for ranking related people given a person or community query, but it is extendable to other combinations of objects.

The described method, system and computer product allow the association of objects with different association or relationship types.

A formula for indirect relationship calculation is described which fits all combinations of category C and query q, and considering additional data. An example of additional data to be considered is normalization—for some combination of categories the overall number of times the category was used in the system should affect the category's score. Often the score of the categories depends on the association of each to the document. So for example if the query person q is a manager and the person C is an employee then this should be scored differently than if both of them just tagged the same document. Thus, scoring is a function of the type of categories, their relationship to the document found and the type of the document. Therefore, an indirect relationship formula should be for example:

Score (C,q)=Sum (over all docs d related to C) [f(d, C, t(C), a(C,d), q, t(q), a(q,d))]

where t(e) is the type of category e, and a(e,d) is the association type of category e to document d.

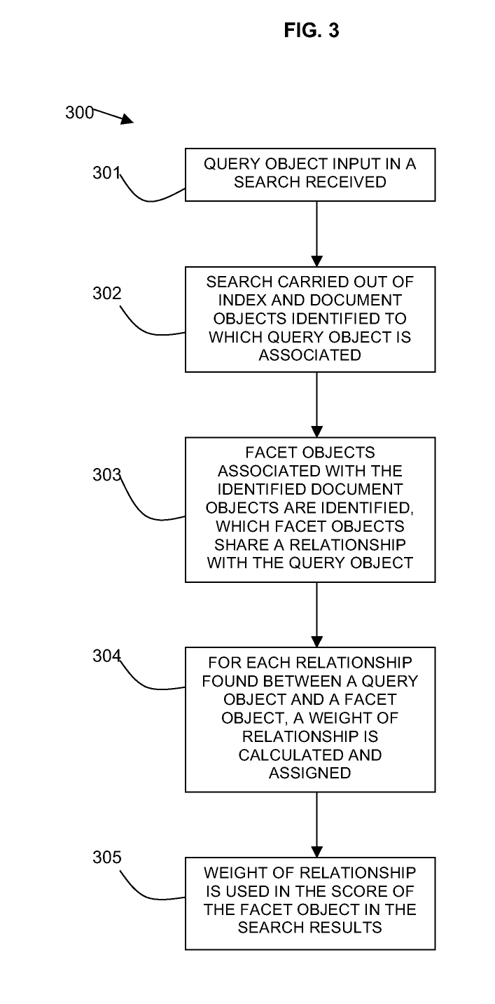

Referring to FIG. 3, a flow diagram 300 shows the overall method of calculating indirect object to object relationship scores.

The method is described using the following terminology:
a query object which is an object for which a search query is being carried out;
a document object which is an indexed document representing an object; and
a facet object which is an object referenced in a facet of the indexed document.
   In each case the object may be any type of object, for example, a web page, user, tag, etc.

A query object is received 301 as input in a search engine. A search is carried out of the index and document objects are identified 302 as documents to which the query object is associated. Facet objects associated with the identified document objects are identified 303 which facet objects share a relationship with the query object. For each relationship found, a weight of relationship is calculated and assigned 304. The weight of the relationship is used 305 to the score of the facet object in the search results.

Definitions are configured for the described method as follows.

Relationship types between entities are defined including for each relationship type:
A document object type;
A query object type and association;
An facet object type and association; and
A normalization basis.

Relationship sets are defined. In one embodiment, the relationship sets are:
Familiarity relationships;
Similarity relationships; and
All relationships.
   Weights for relationship types in each set are defined.

A query object q and a facet object f are in a relationship r for a given document object d of document object type t, if the following are true:
The defined relationship type of r contains the document object type t;
Query object q matches r's query object type, and it is associated to document object d by r's query association;
Facet object f matches r's facet object type, and it is associated to document object d by r's facet association type.

If these conditions hold, the contribution to the relevance score of facet object f to the query object q from the pair (r,d) is as follows:
score(f|q,d,r)=weight(r)/norm(r)[d,r,q,f]

Weight(r) is the weight of relationship r in the relationship set currently used for ranking (for example, familiarity, similarity, or all). Norm(r) is a normalization function. This function may be defined and examples are two such functions:
1. Member: The total number of people associated to d (with any association type), and
2. Evidence: An additional data structure named EVIDENCE holds for each entity type e the set of triplets (object o of entity type e, association a of entity type e, document object type t) which appear in the system. For each such triplet, the number of documents of type t to which object o is associated with association a is kept. The evidence normalization is therefore EVIDENCE(e, queryAssociation(r), t)+EVIDENCE(q, facetAssociation(r), t). This is done to reduce the scores of more frequent objects of a certain document object type, in a way similar to the use of IDF (Inverted Document Frequency) in textual search.

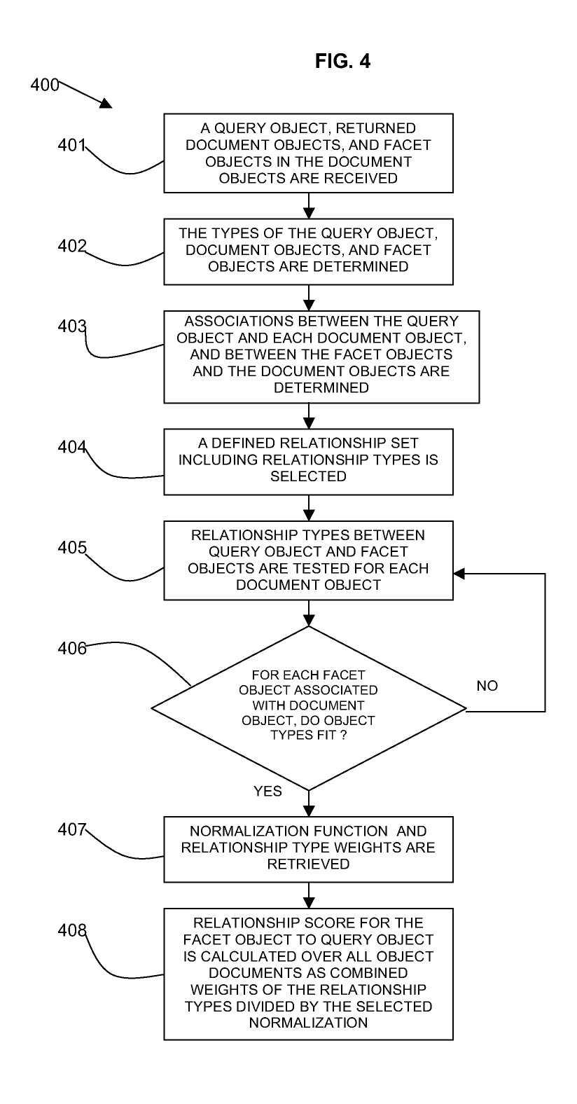

Referring to FIG. 4, a flow diagram 400 shows a method of scoring a relationship between objects.

A query object, document objects returned in search results for the query object, and facet objects in the returned document objects are received 401. The types of the query object, document objects, and facet objects are determined 402. The associations between the query object and the document objects and the associations between the facet objects and the document objects are determined 403.

A defined relationship set is selected 404 including relationship types and relationship type weights.

For each document object, a relationship type between the query object and the document object facet objects are tested 405. For each facet object it is determined 406 if the query object type, facet object type, and document object type match for the relationship type. If the types do not match, the method moves to the next facet object.

If the types match, the normalization function to be used for the relationship type and the relationship type weights are retrieved 407 for the relationship set being used.

The relationship score for the facet object to the query object is then calculated 408 over all object documents as the combined weights of the relationship types divided by the selected normalization.

The relationship score for the facet object is used to rank facet objects indirectly related to a query object in search results.

In order to support a generic function, during the calculation of the weight of facet object f for the query object q in the context of document object d, the weight calculation in the faceted search engine must be able to incorporate the following:
The document ID;
An identifier of facet f;
An identifier of the query object q
The type of facet object f;
The type of query object q (e.g. whether it is a term or person query);
The type of association between f and d; and
The type of association between q and d.

The following includes a description of an example mechanism of scoring related people given a person query. The query object is a person query, the document object is a retrieved document, and a facet object is a person related to a retrieved document and therefore has a reference stored in the document facet in the search index.

There are two components in the mechanism: configuration and runtime. The search in this example relates to documents and people. A person can be associated to a certain document with several of these pre-defined association types: author, tagger, commenter.

The following are examples of a configuration file. Each “map” element contains the definition for one relationship type between two people.

<node name=“Relationships”>

<map>

<entry key=“desc” value=“Paper Co Authorship”/>
<entry key=“docType” value=“Paper”/>
<entry key=“queryType” value=“author”/>
<entry key=“facetType” value=“author”/>

<entry key=“norm” value=“member”/>
</map>
<map>

<entry key=“desc” value=“Patent Co Authorship”/>
<entry key=“docType” value=“Patent”/>
<entry key=“queryType” value=“author”/>
<entry key=“facetType” value=“author”/>
<entry key=“norm” value=“member”/>

</map>
<map>

<entry key=“desc” value=“Blog Post Comment By”/>
<entry key=“docType” value=“Blog”/>
<entry key=“queryType” value=“author”/>
<entry key=“facetType” value=“commenter”/>
<entry key=“norm” value=“evidence”/>

</map>
<map>

<entry key=“desc” value=“Blog Post Comment To”/>
<entry key=“docType” value=“Blog”/>
<entry key=“queryType” value=“commenter”/>
<entry key=“facetType” value=“author”/>
<entry key=“norm” value=“evidence”/>

</map>
<map>

<entry key=“desc” value=“Co tagging (bookmark) by”/>
<entry key=“docType” value=“Webpage,Blog”/>
<entry key=“queryType” value=“tagger”/>
<entry key=“facetType” value=“tagger”/>
<entry key=“norm” value=“evidence”/>

</map>
<map>

<entry key=“desc” value=“Blog Post Co Comment”/>
<entry key=“docType” value=“Blog”/>
<entry key=“queryType” value=“commenter”/>
<entry key=“facetType” value=“commenter”/>
<entry key=“norm” value=“evidence”/>

</map>

</node>

Another part of the configuration defines three different relationship sets, one with relationships inferring familiarity, a second with relationships inferring similarity, and the last with a combination of all relationships. Within these sets a weight is assigned to each relationship type:

<node name=“familiarity”>

<map>

<entry key=“BI” value=“sum{ $Relationships }”/>
<entry key=“desc” value=“All familiarity relationships”/>

</map>
<node name=“Relationships”>

<map>

<entry key=“Blog Post Comment To” value=“0.1”/>
<entry key=“Blog Post Comment By” value=“0.5”/>

<entry key=“Patent Co Authorship” value=“5”/>
<entry key=“Paper Co Authorship” value=“5”/>

</map>

</node>

</node>
<node name=“similarity”>

<map>

<entry key=“BI” value=“sum{ $Relationships }”/>
<entry key=“desc” value=“All similarity relationships”/>

</map>
<node name=“Relationships”>

<map>

<entry key=“Blog Post Co Comment” value=“1”/>
<entry key=“Co tagging (bookmark) by” value=“1”/>

</map>

</node>

</node>
<node name=“all”>

<map>

<entry key=“BI” value=“sum{ $Relationships }”/>
<entry key=“desc” value=“All relationships”/>

</map>
<node name=“Relationships”>

<map>

<entry key=“Blog Post Comment To” value=“0.1”/>
<entry key=“Blog Post Comment By” value=“0.5”/>

<entry key=“Patent Co Authorship” value=“5”/>
<entry key=“Paper Co Authorship” value=“5”/>
<entry key=“Blog Post Co Comment” value=“0.2”/>
<entry key=“Co tagging (bookmark) by”
value=“0.2”/>

</map>

</node>

</node>

A person query p1 and another person p2 are in relationship r for a given document d of docType t, if the following is true:
the docType of r contains t;
the association of p1 to d matches r's queryType;
the association of p2 to d matches r's facetType.

If these conditions hold, the contribution to person p2's relevance score to the query p1 from the pair (r,d) is as follows:
score(p2|p1,d,r)=weight(r)/norm(r)[d,r,p1,p2]

To illustrate the calculation, an example is used with four people (p1 to p4) and 10 documents (d1 to d10). Table 1 below describes the document types and the association each person has with each document:

TABLE 1

| | | p1 | p2 | p3 as- | p4 |
|---|---|---|---|---|---|
| Doc | docType | associations | associations | sociations | associations |
| d1 | Webpage | Tagger | Tagger | | |
| d2 | Webpage | Tagger | | Tagger | |
| d3 | Webpage | Tagger | | | |
| d4 | Blog | Author | Tagger | | Commenter |
| d5 | Blog | Author | Commenter | | Commenter |
| d6 | Blog | Tagger, | | | |
| | | Commenter | | | |
| d7 | Blog | | Author | | |
| d8 | Paper | Author | Author | | |
| d9 | Paper | | | Author | |
| d10 | Paper | Author | Author | | Author |

The next table, Table 2, contains the EVIDENCE data:

TABLE 2

| Association | docType | p1 | p2 | p3 | p4 |
|---|---|---|---|---|---|
| Tagger | Webpage | 3 | 1 | 1 | 0 |
| Author | Blog | 2 | 0 | 0 | 1 |
| Tagger | Blog | 0 | 1 | 0 | 0 |
| Commenter | Blog | 1 | 1 | 0 | 3 |
| Author | Paper | 1 | 1 | 1 | 0 |
| Author | Patent | 1 | 1 | 0 | 1 |

(Note: only lines which are not all 0 are shown)

The first calculation will be of people related to p2 under the familiarity relationships:

d1: (Webpage,p2,p1) fulfils “Co tagging (bookmark) by”, but it is not in the familiarity set
d2: p2 not associated
d3: p2 not associated
d4: no relationship fulfilled
d5: (Blog,p2,p1) fulfils “Blog Post CommentTo”, score(p1)=0.1/(1+2)=0.03333
d6: p2 not associated
d7: no relationship fulfilled
d8: (Paper,p2,p1) fulfils “Paper Co Authorship”, score(p1)=0.03333+5/2=2.53333
d9: p2 not associated
d10: (Patent,p2,p1) fulfils “Paper Co Authorship”, score(p1)=2.53333+5/3=4.2
(Patent,p2,p4) fulfils “Paper Co Authorship”, score(p4)=5/3=1.6666

Final list: p1 with score 4.17, p4 with score 1.6666

The second calculation will be of people related to p1 under the similarity relationships:

d1: (Webpage,p1,p2) fulfils “Co tagging (bookmark) by”, score(p2)=1/(3+1)=0.25
d2: (Webpage,p1,p3) fulfils “Co tagging (bookmark) by”, score(p3)=1/(3+1)=0.25
d3: no relationship fulfilled
d4: no relationship fulfilled
d5: (Blog,p1,p2) fulfils “Blog Post CommentTo”, but it is not in the similarity set
d6: no relationship fulfilled
d7: p1 not associated
d8: (Paper,p1,p2) fulfils “Paper Co Authorship”, but it is not in the similarity set
d9: p1 not associated
d10: (Patent,p1,p2) and (Patent,p1,p4) fulfils “Paper Co Authorship”, but it is not in the similarity set

Final list: p2 with score 0.25, p3 with score 0.25

The third and last calculation will be of people related to p4 under the “all” relationships:

d1: p4 not associated
d2: p4 not associated
d3: p4 not associated
d4: (Blog,p4,p1) fulfils “Blog Post CommentTo”, score(p1)=0.1/(3+2)=0.02
d5: (Blog,p4,p1) fulfils “Blog Post CommentTo”, score(p1)=0.02+0.1/(3+2)=0.04
(Blog,p4,p2) fulfils “Blog Post Co Comment”, score(p2)=0.2/(3+1)=0.025
d6: (Blog,p4,p1) fulfils “Blog Post Comment By”, score(p1)=0.04+0.5/(1+1)=0.29
(Blog,p4,p1) fulfils “Blog Post Co Comment”, score(p1)=0.29+0.2/(3+1)=0.34
d7: p4 not associated
d8: p4 not associated
d9: p4 not associated
d10: (Patent,p4,p1) fulfils “Paper Co Authorship”, score(p1)=0.34+5/3=2.00666
(Patent,p4,p2) fulfils “Paper Co Authorship”, score(p2)=5/3=1.6666

Final list: p1 with score 2.00666, p2 with score 1.6666

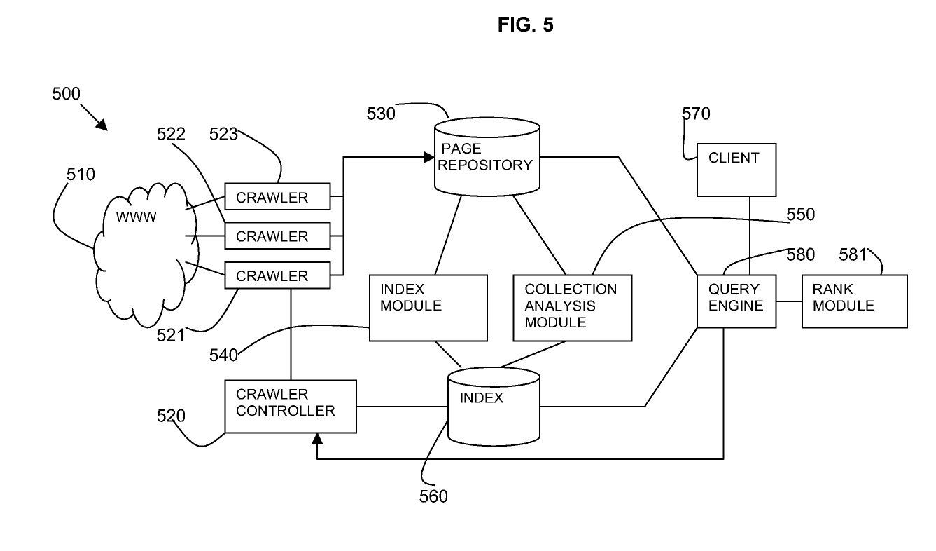

A system in which the described relationship scoring of search object is now described. Referring to FIG. 5, an embodiment of an information retrieval system in the form of a search engine 500 is shown as known in the prior art.

A search engine 500 fetches documents to be indexed from the World Wide Web 510, or from resources on an intranet. The search engine 500 includes a crawl controller 520 which controls multiple crawler applications 521-523 which fetch documents which are stored in a page repository 530.

The documents stored in the page repository 530 are profiled by a collection analysis module 550 and indexed by an index module 540. One or more index 560 is maintained with text, structure, and utility information of the documents.

A client 570 can input a query to a query engine 580 which retrieves relevant documents from the page repository 530. The query engine 580 may include a ranking module 581 for ranking returned documents. The returned documents are provided as results to the client 570. User feedback from the query engine 580 may be provided to the crawl controller 520 to influence the crawling.

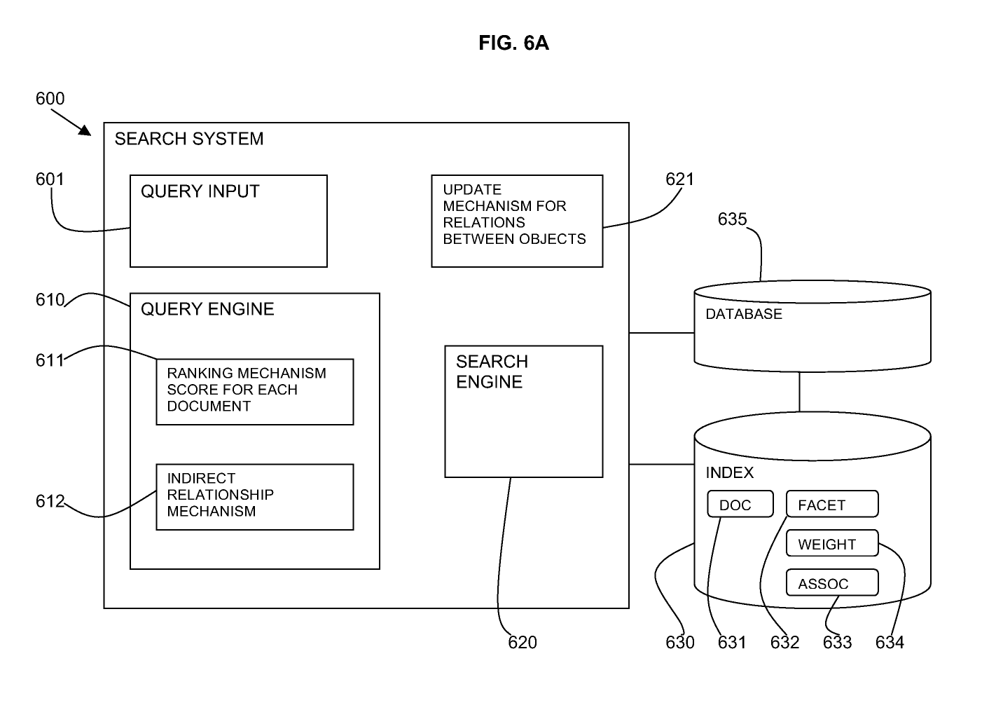

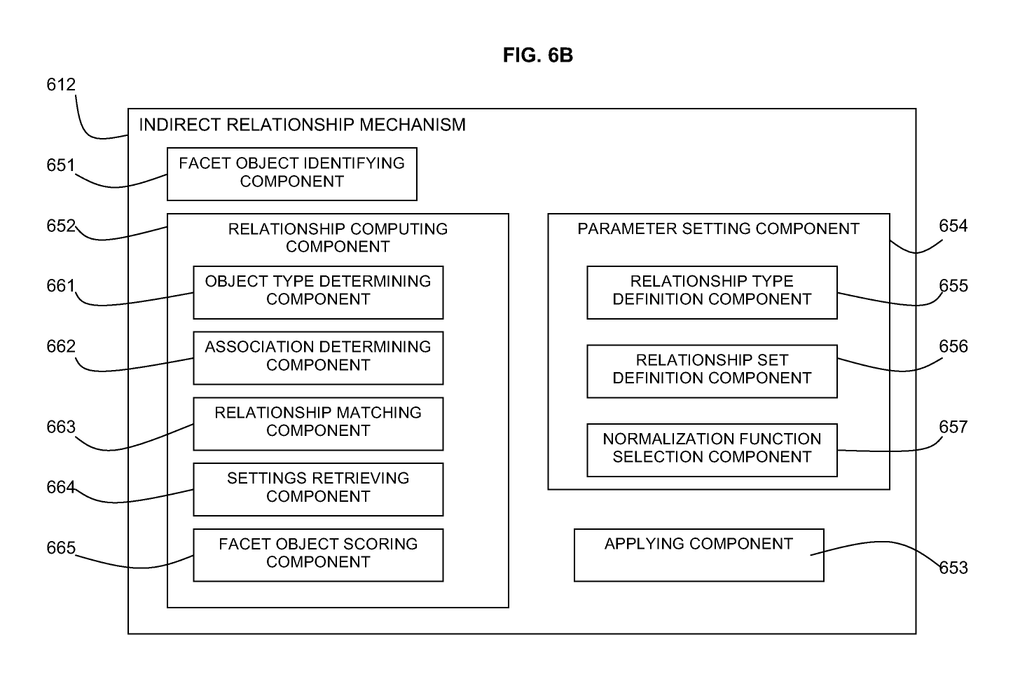

Referring to FIG. 6A, a block diagram shows a search system 600 in accordance with the described system. The search system 600 includes an index 630 and search engine 620 with objects indexed in the system in two ways: as a retrievable document 631 and as a facet (category) 632 of all the objects it relates to. Each direct relation between two objects is defined by attaching a facet representing one object to a document representing the other object. The relationship between objects is represented by an association 633 in the facet-document relationship. A weighting 634 is also provided for weighting a relationship strength in the facet-document relationship.

The search system 600 includes a query input mechanism 601 for inputting a query with an object type for the query. A query engine 610 includes a ranking mechanism 611 for scoring for each document based on the relation strength between a query facet and a document. The query engine 610 also includes an indirect relationship mechanism 612 for computing indirect relation scores between objects describe further in FIG. 6B.

The search system 600 also includes an update mechanism 621 for updating relations between objects in the index. The updating mechanism 621 can be used to update existing relation weightings and to add facets and weightings to objects already stored as documents in the index. The relationship weightings may be stored in a database 635.

Referring to FIG. 6B, further details of the indirect relationship mechanism 612 are shown. The indirect relationship mechanism 612 includes a facet object identifying component 651 for identifying facet objects associated with the identified document objects and which share a relationship with the query object. The indirect relationship mechanism 612 includes a relationship computing component 652 and for each relationship found, a weight of relationship is calculated and assigned to a facet object. The indirect relationship mechanism 612 also includes an applying component 653 for applying the relationship weight to the search results.

The indirect relationship mechanism 612 includes a parameter setting component 654 including a relationship type definition component 655, a relationship set definition component 656, and a normalization function selection component 657.

The relationship computing component 652 includes an object type determining component 661 for determining the types of the query object, document object, and facet object in order to determine if these fit relationship types. The relationship computing component 652 includes an association determining component 662 for determining an association between the query object and document object, and the facet object and document object in order to determine which relationship type these belong to.

The relationship computing component 652 also includes a relationship matching component 663 determines a relationship type between the query object and a facet object for each document object and for each document object determines if the query object type, facet object type, and document object type match for the relationship type.

The relationship computing component 652 includes a settings retrieving component 664 for retrieving the normalization method to be used for the relationship type and the relationship type weights for the relationship set being used.

The relationship computing component 652 also includes a facet object scoring component 665 for calculating the relationship score for the facet object to the query object over all object documents as the combined weights of the relationship types divided by the selected normalization.

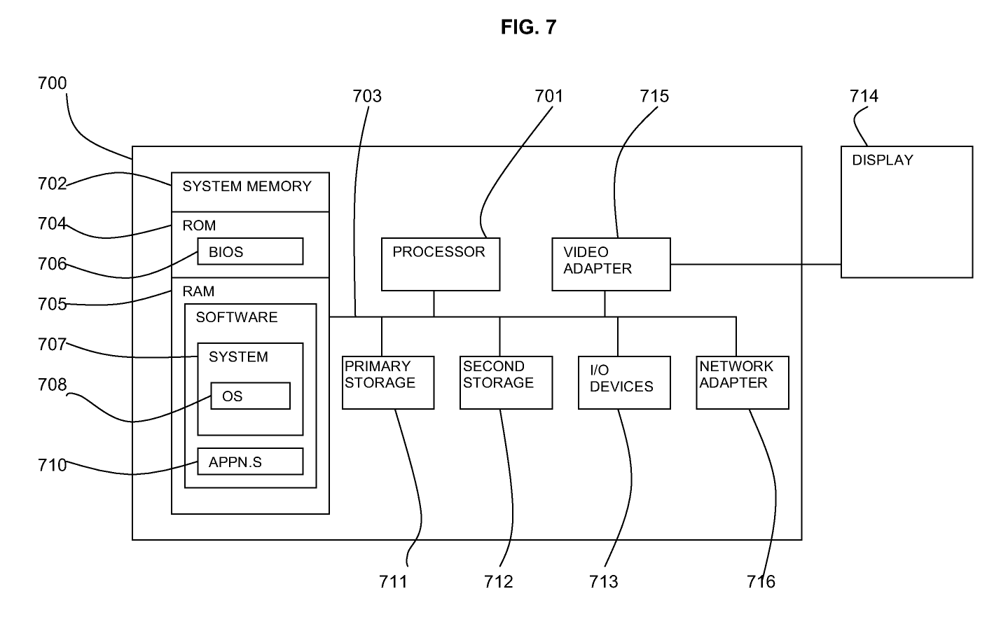

Referring to FIG. 7, an exemplary system for implementing aspects of the invention includes a data processing system 700 suitable for storing and/or executing program code including at least one processor 701 coupled directly or indirectly to memory elements through a bus system 703. The memory elements can include local memory employed during actual execution of the program code, bulk storage, and cache memories which provide temporary storage of at least some program code in order to reduce the number of times code must be retrieved from bulk storage during execution.

The memory elements may include system memory 702 in the form of read only memory (ROM) 704 and random access memory (RAM) 705. A basic input/output system (BIOS) 706 may be stored in ROM 704. System software 707 may be stored in RAM 705 including operating system software 708. Software applications 710 may also be stored in RAM 705.

The system 700 may also include a primary storage means 711 such as a magnetic hard disk drive and secondary storage means 712 such as a magnetic disc drive and an optical disc drive. The drives and their associated computer-readable media provide non-volatile storage of computer-executable instructions, data structures, program modules and other data for the system 700. Software applications may be stored on the primary and secondary storage means 711, 712 as well as the system memory 702.

The computing system 700 may operate in a networked environment using logical connections to one or more remote computers via a network adapter 716.

Input/output devices 713 can be coupled to the system either directly or through intervening I/O controllers. A user may enter commands and information into the system 700 through input devices such as a keyboard, pointing device, or other input devices (for example, microphone, joy stick, game pad, satellite dish, scanner, or the like). Output devices may include speakers, printers, etc. A display device 714 is also connected to system bus 703 via an interface, such as video adapter 715.

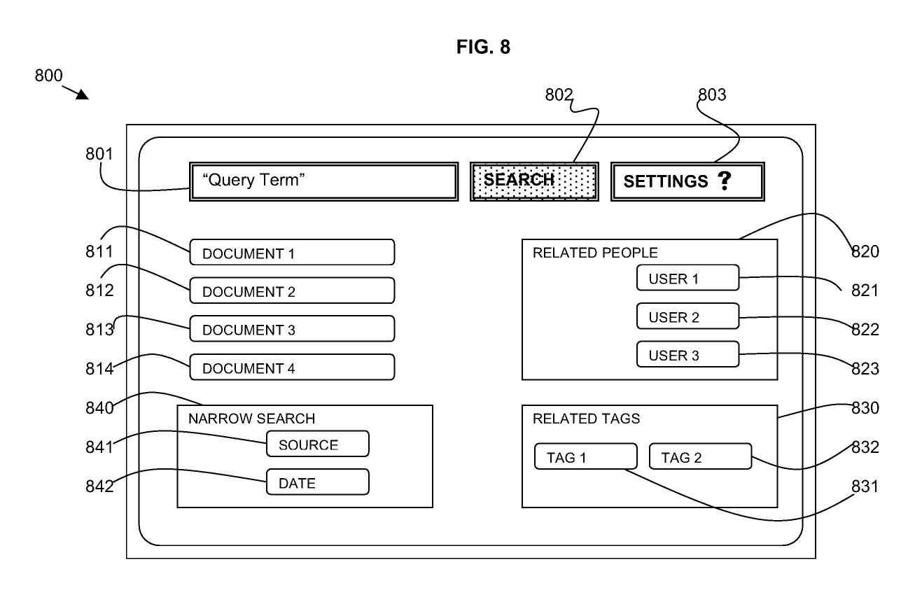

A social search application GUI is shown in FIG. 8 in the form of a screen 800 of the application for an object query. A query input box 801 is provided with a search activate button 802. A settings menu 803 is also provided for designating the object type of the object search.

The returned document results are listed 811-814 with links to the returned documents. In addition, a list of “related people” 820 is returned which shows the users 821-823 deemed related to the set of documents retrieved 811-814. A list of related tags 830 is also returned in the form of a tag cloud showing the frequency of tags 831, 832 used to describe the set of retrieved documents 811-814. A list of additional categories 840 is also provided with which the information can be further explored, for example sources 841 of the documents 811-814 and dates 842 of the documents 811-814.

The indirect relationship scores of the related objects such as related people 821-823 and tags 811-814 to the query object are used to rank the related objects.

The searchable indexed objects are documents, users and tags. When searching for an object such as a specific user or specific tag, the system provides direct related documents (all documents directly related to this specific object) as well as all indirect related users and tags to the given query.

A further example of a weight function which could be calculated using the described method is shown below. It is a normalization of the case where the query is a person p1 which is related to the person facet p2 through the same association. Their score is computed as the intersection of common documents they are related to through the association divided by the union (also known as Jaccard index). This could for example be used to compute the score of tagging relationships between people which is the number of tagged documents they have in common divided by the number of total documents they have tagged together. In this case the association would stand for “tagging”.

The weighted faceted search system allows associating entities or objects to documents with different association types. The calculation of the score of one object given another object as the query is done in two steps:
1. Identify the documents to which the query object is associated; and
2. Find objects that are associated to the document and share some relationship with the query object.

For each found relationship, a weight is assigned according to a combination of parameters. This weight is added to the score of the object which is not the query object.

Previously, each association of an object to a document had a single weight. Therefore, given a query object and a document to which it is associated, the score added to any of the other objects was calculated by multiplying the weights of the two objects. Here, only if the two objects share a relationship is the score updated, and the contribution of each relationship to the score can be weighted and normalized differently.

An object relationship scoring system for a faceted search system may be provided as a service to a customer over a network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for scoring relationships between objects in information retrieval, comprising:
receiving a query object as an input in a search, wherein the query object is a query for a searchable entity type;
identifying indexed document objects associated with the query object;
identifying facet objects referenced in the indexed document objects, which facet objects share a defined relationship type with the query object;
calculating for each relationship between a facet object and the query object a weight of relationship;
wherein a query object, document object, and facet object can represent any searchable entity; and
wherein said steps are implemented in either:
computer hardware configured to perform said identifying, tracing, and providing steps, or
computer software embodied in a non-transitory, tangible, computer-readable storage medium.

2. The method as claimed in claim 1, wherein calculating a weight of relationship calculates the weight of relationships over all document objects divided by a defined normalization.

3. The method as claimed in claim 1, wherein calculating a weight of relationship includes retrieving a weight and normalization for a relationship type.

4. The method as claimed in claim 1, wherein calculating a weight of relationship is a function of the type of facet object, the type of query object, the relationship types of the facet object and query object to the document object, and the type of document object.

5. The method as claimed in claim 1, including determining an object type of the query object, document objects, and facet objects, and determining associations between the query object and the document objects, and between the facet objects and the document objects.

6. The method as claimed in claim 1, including:
defining relationship types including allowed query object type, document object type, and facet object type for the relationship type.

7. The method as claimed in claim 6, wherein defining a relationship type includes defining a normalization function to be used for calculating a weight of relationship of the relationship type.

8. The method as claimed in claim 6, including:
assigning a weight to a relationship type to be used for calculating a weight of relationship of this relationship type.

9. The method as claimed in claim 6, wherein calculating a weight of relationship calculates the weight over all document objects as combined weights of the relationship types divided by the normalization for the relationship type.

10. The method as claimed in claim 6, wherein calculating a weight of relationship includes determining if the query object type, document object type, and facet object type fit the relationship type and calculating the weight if the object types fit.

11. The method as claimed in claim 6, including:
selecting a defining relationship type set from multiple defined relationship type sets for different levels of relationship type weighting.

12. The method as claimed in claim 1, wherein the searchable entities include one or more of the group of: people, documents, web pages, tags, blogs, blog inputs.

13. The method as claimed in claim 1, including:
using the weight of relationship in the score of the facet object in the search results of the query object.

14. A computer program product for aggregation of social network data, the computer program product comprising:
a computer readable storage medium having computer readable program code embodied therewith, the computer readable program code comprising:
computer readable program code configured to:
receive a query object as an input in a search, wherein the query object is a query for a searchable entity type;
identify indexed document objects associated with the query object;
identify facet objects referenced in the indexed document objects, which facet objects share a defined relationship type with the query object;
calculate for each relationship between a facet object and the query object a weight of relationship;
wherein a query object, document object, and facet object can represent any searchable entity.

15. A system for scoring relationships between objects in information retrieval, comprising:
a processor;
a query engine for receiving a query object as an input in a search, wherein the query object is a query for a searchable entity type, and for returning results from a search engine of indexed document objects associated with the query object;
an indirect relationship mechanism including:
a facet object identifying component for identifying facet objects referenced in the indexed document objects, which facet objects share a defined relationship type with the query object; and
a relationship computing component for calculating for each relationship between a facet object and the query object a weight of relationship;
wherein a query object, document object, and facet object can represent any searchable entity.

16. The system as claimed in claim 15, wherein the indirect relationship mechanism further includes:
a parameter setting component for defining relationship types including:
a relationship type definition component for defining allowed query object type, document object type, and facet object type for the relationship type, and for defining a weight of a relationship type to be used for calculating a weight of relationship of the relationship type;
a normalization function selection component for selecting a normalization function to be used for calculating a weight of relationship of the relationship type.

17. The system as claimed in claim 15, wherein the relationship computing component calculates a weight of relationship including a weight and normalization to be applied to a relationship type.

18. The system as claimed in claim 15, wherein the relationship computing component includes:
an object type determining component for determining the type of facet object, the type of query object, and the type of document object; and
an association determining component for determining the relationships of the facet object and query object to the document object.

19. The system as claimed in claim 15, wherein the relationship computing component includes:
a relationship matching component for determining if the query object type, document object type, and facet object type fit the relationship type.

20. The system as claimed in claim 15, wherein the relationship computing component includes:
a facet object scoring component for calculating a weight of relationship types over all document objects as combined weights of the relationship types divided by the normalization for the relationship type.

21. The system as claimed in claim 15, including:
a relationship set definition component for defining relationship type sets for different levels of relationship type weighting.

22. The system as claimed in claim 15, wherein the searchable entities include one or more of the group of: people, documents, web pages, tags, blogs, blog inputs.

23. The system as claimed in claim 15, including:
an applying component for using the weight of relationship in the score of the facet object in the search results of the query object.

24. A method of providing a service to a customer over a network for scoring relationships between objects in information retrieval, the service comprising:
receiving a query object as an input in a search, wherein the query object is a query for a searchable entity type;
identifying indexed document objects associated with the query object;
identifying facet objects referenced in the indexed document objects, which facet objects share a defined relationship type with the query object;
calculating for each relationship between a facet object and the query object a weight of relationship;
wherein a query object, document object, and facet object can represent any searchable entity; and
wherein said steps are implemented in either:
computer hardware configured to perform said identifying, tracing, and providing steps, or
computer software embodied in a non-transitory, tangible, computer-readable storage medium.
